(19) United States
(12) Patent Application Publication
(10) Pub. No.: US 2016/0154681 A1
(43) Pub. Date: Jun. 2, 2016

(54) DISTRIBUTED JOBS HANDLING

(71) Applicant: INTERNATIONAL BUSINESS MACHINES CORPORATION, Armonk, NY (US)

(72) Inventors: FEI CHEN, BEIJING (CN); GUAN CHENG CHEN, BEIJING (CN); H. PETER HOFSTEE, AUSTIN, TX (US); LIU TAO, BEIJING (CN); KUN WANG, BEIJING (CN); YU ZHANG, BEIJING (CN)

(21) Appl. No.: 14/951,630

(22) Filed: Nov. 25, 2015

(30) Foreign Application Priority Data
Nov. 28, 2014 (CN) 201410708534.X

(51) Int. Cl. G06F 9/50

(52) U.S. Cl. CPC G06F 9/5083

(57) ABSTRACT

Embodiments include methods, systems and computer program products for handling a distributed job by a FPGA. Aspects include obtaining a demand for performance in the distributed job and determining, according to the demand for performance, whether to reconfigure the FPGA. Aspects also include dynamically reconfiguring at least a part of the FPGA in response to determination of reconfiguring the FPGA. With the method and corresponding system, the performance of the distributed job can be effectively improved.

### FOREIGN PRIORITY

This application claims priority to Chinese Patent Application No. 201410708534.X; filed Nov. 28, 2014, and all the benefits accruing therefrom under 35 U.S.C. §119, the contents of which in its entirety are herein incorporated by reference.

### BACKGROUND

The present invention relates to distributed jobs, and more specifically, to a method and system for handling a distributed job.

At present, as distributed computer networks prevail, more and more tasks are handled in a manner of distributed jobs. These distributed jobs usually contain complex workload. Take MapReduce as an example. MapReduce has various different functions which need to be accelerated, such as compression, decompression, sorting, crc32 (Cyclic Redundancy Check), etc. In execution of these distributed jobs, there exist different demands for performance, e.g., it is desirable to complete these distributed jobs with shorter time or less resource occupation, or to achieve load balance for various units of the distributed system, where load imbalance is a very common issue in MapReduce workload which significantly affects performance of the distributed jobs.

During the handling of these distributed jobs, FPGA (Field Programmable Gate Array) is often used to accelerate various functions in the distributed jobs. FPGA, as a semi-customized circuit in the field of Application Specific Integrated Circuit (ASIC), is widely used to accelerate operation of various applications.

FPGA logic is achieved by uploading programmable data to internal static memory units, and logic function of logic units and coupling manners between modules or between modules and I/O is determined by values stored in the memory units, thereby the functions achieved by FPGA being determined.

Current FPGA reconfiguration is completed online, and the logic is usually rebuilt by refreshing the configuration files. Although FPGA can accelerate various functions of distributed jobs to a certain degree, when the demand for performance in the distributed jobs changes, e.g., when workload imbalance occurs, the FPGA acceleration cannot solve the load imbalance issue.

### SUMMARY

In view of the above problems, it is desirable to provide a solution that can improve performance in distributed jobs.

According to one aspect of the present invention, there is provided a method for handling a distributed job, wherein the distributed job is handled by a FPGA. The method comprises obtaining a demand for performance in the distributed job, determining, according to the demand for performance, whether to reconfigure the FPGA, and dynamically reconfiguring at least a part of the FPGA in response to determination of reconfiguring the FPGA.

According to another aspect of the present invention, there is provided a system for handling a distributed job, wherein the distributed job is handled by a FPGA. The system comprises a performance demand obtaining module configured to obtain a demand for performance in the distributed job, a reconfiguration determining module configured to determine, according to the demand for performance, whether to reconfigure the FPGA, and a reconfiguration executing module configured to dynamically reconfigure at least a part of the FPGA in response to determination of reconfiguring the FPGA.

With the method and corresponding system according to the above aspects of the present invention, the performance of the distributed job can be effectively improved.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 illustrates a block diagram of an exemplary computer system/server 12 which is applicable to implement the embodiments of the present invention;

FIG. 2 illustrates a flow chart of a method for handling a distributed job according to an embodiment of the present invention;

FIG. 3A illustrates an example of parallelism of Map tasks and Reduce tasks of a MapReduce job;

FIG. 3B illustrates an example of parallelism of Map tasks and Reduce tasks after acceleration of a FPGA;

FIG. 3C illustrates an example of parallelism of Map tasks and Reduce tasks after acceleration of the reconfigured FPGA; and

FIG. 4 illustrates a block diagram of a system for handling a distributed job according to an embodiment of the present invention.

### DETAILED DESCRIPTION

Exemplary embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

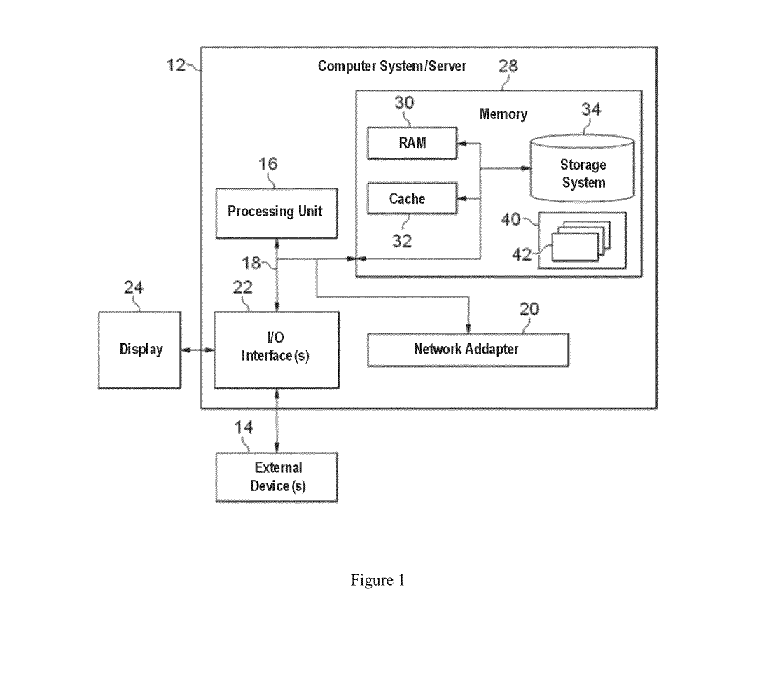

FIG. 1 illustrates a block diagram of an exemplary computer system/server 12 which is applicable to implement the embodiments of the present invention. The computer system/server 12 shown in FIG. 1 is only an example and should not bring any limitations to functions and application scope of embodiments of the present invention.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

As mentioned above, FPGA is being widely applied to accelerate operation of various applications. Before introducing embodiments of the present invention, FPGA is first briefly introduced. FPGA resources include area resources, PCIe resources, and the like, wherein the area resources refer to chip resources of the FPGA and include logic resources and/or I/O resources. Accelerators with different complexities need to occupy FPGA areas of different sizes, and resulting acceleration performance also varies. In some cases, area duplication may achieve in improvement of speed and as the supported speed is higher, product performance to be achieved may be higher. For example, a plurality of accelerators of the same type may be configured on the FPGA, thereby enhancing acceleration of certain applications.

Accelerators of the FPGA should be generally pre-compiled. If compiling is performed in situ, a period of several hours is usually required.

As cloud computing prevails, it is desirable to provide online reconfiguration for the FPGA. For example, under cloud setting, a physical FPGA card may be shared by a plurality of users, and different users may need to reconfigure partial logic units of this FPGA card based on their specific demands, or there exist a FPGA pool consisting of a plurality of physical FPGA cards, and the respective FPGA cards in the FPGA pool may be shared by a plurality of distributed tasks located at different hosts.

Different users or tasks have different demands for performance, and the demands vary at different stages. Therefore, it is desirable to provide a method and system for handling distributed tasks that is applicable to meet the different demands.

FPGA dynamic reconfiguration technology means dynamic functional transformation of all or partial logic resources of FPGA in the system, and a dynamic reconfigurable FPGA is a novel FPGA chip that can implement dynamic configuration in the system based on the dynamic configuration technology. Compared with the static system reconfiguration, dynamic partial reconfiguration shortens time for reconfiguration, and during the reconfiguration, non-reconfiguration part still runs, and data in the registers thereof will not be lost, thereby overhead for reconfiguring the system being reduced and running efficiency of the system is improved.

On the basis of the current FPGA dynamic reconfiguration technology, there is proposed herein a method and system for handling distributed tasks according to embodiments of the present invention.

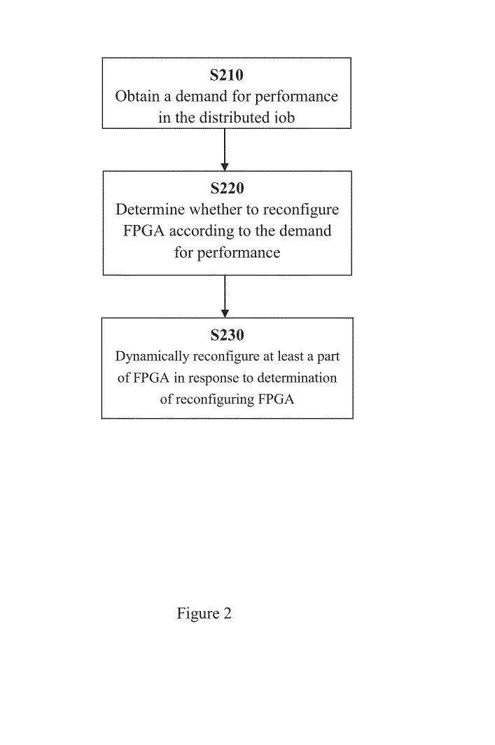

FIG. 2 illustrates a flow chart of a method for handling a distributed job according to an embodiment of the present invention.

According to an embodiment of the present invention, the distributed job may for example be a MapReduce job. MapReduce is a common programming model for parallel computing of big data set, wherein Map operation and Reduce operation may both be highly parallelized. Map operation and Reduce operation usually have different functions to be accelerated, for example, compression, decompression, sorting, crc32 (Cyclic Redundancy Check), etc. Therefore, a FPGA may be used to handle the MapReduce job, and functions such as compression or decompression may be implemented by means of acceleration performance of the FPGA.

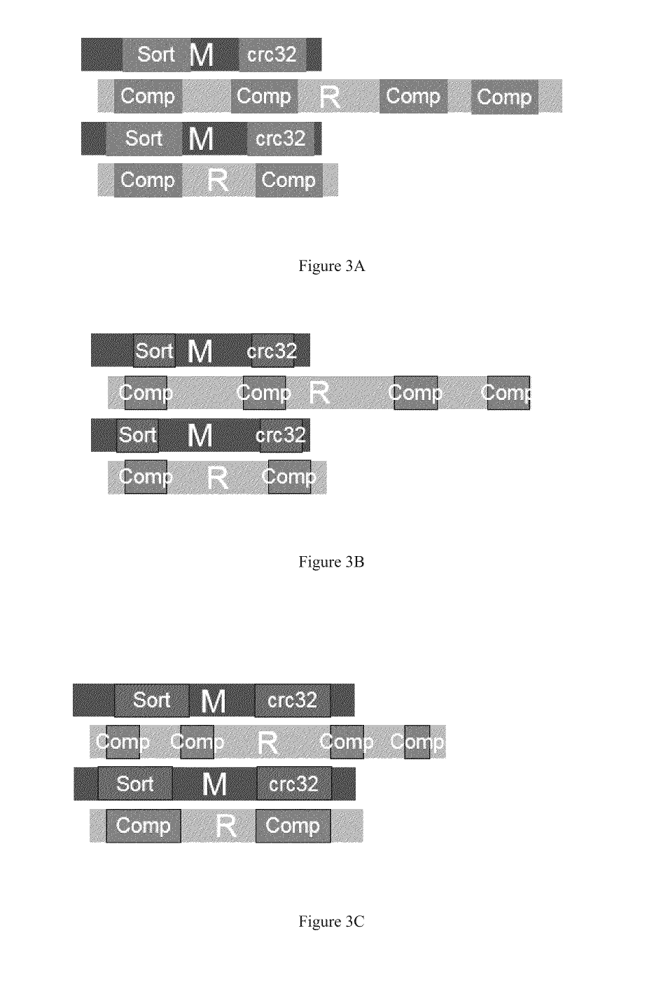

FIG. 3A illustrates an example of parallelism of Map tasks and Reduce tasks in a MapReduce job, wherein the first and third lines indicate Map tasks including “sort” functions and “crc32” functions, and the second and fourth lines indicate Reduce tasks including “comp” (compression) functions.

FIG. 3B illustrates an example of parallelism of Map tasks and Reduce tasks after acceleration of a FPGA. It can be seen therefrom that as compared with FIG. 3A, time for executing “sort” functions and “crc32” functions in the Map tasks and “comp” (compression) functions in the Reduce tasks is substantially reduced after acceleration of the FPGA in FIG. 3B, so that the Map tasks and the Reduce tasks are accelerated respectively.

As shown at block S210, a demand for performance in the distributed job is obtained. During execution of the distributed job, there exist different demands for performance. For example, it is desirable to complete the distributed job with shorter time or less resource occupation, or to achieve load balance for various units of the distributed system.

Due to properties of the distributed job per se, load imbalance often occurs in the distributed job, which results in apparent influence on the performance. For example, as can be seen from FIG. 3A and FIG. 3B, the time for executing the Reduce task in the second line is obviously longer than other Map tasks and Reduce tasks. The time for executing this task is still far longer than other tasks even though the time for executing other tasks is shortened simultaneously after acceleration of the FPGA, so that the performance of the whole distributed job is affected. Therefore, according to an embodiment of the present invention, obtaining the demand for performance in the distributed job may comprise detecting load imbalance in the distributed job.

According to an embodiment of the present invention, the progress of each task of the distributed jobs may be monitored and whether load imbalance exists may be determined according to the progress of each task. Take MapReduce as an example. When MapReduce is running, a counter included the system is used for recording percentage of current progress of each task. Therefore, the current progress of each Map task or Reduce task can be obtained from the counter in real time so as to determine which task(s) prolongs the whole operation time.

As shown at block S220, whether to reconfigure FPGA is determined according to the demand for performance. According to an embodiment of the present invention, when the demand for performance of the distributed job is obtained, an overhead and a predicted benefit for reconfiguring at least a part of the FPGA may be estimated according to the demand for performance, and in response to the predicted benefit being greater than the overhead, at least a part of the FPGA may be determined to be reconfigured.

According to an embodiment of the present invention, the prediction of the benefit may be implemented by using a performance model based on expert knowledge.

MapReduce is taken as an example. Expert knowledge of MapReduce is needed upon determining how to obtain an optimal reconfiguration plan. At different stages, different tasks are performed and there are different demands for performance. Furthermore, the acceleration performance of FPGA varies with different tasks. Take LX330 FPGA manufactured by Xilinx as an example. A typical value of the performance of the FPGA accelerator is presented as follows relative to CPU software implementation.

Regarding the compression algorithm, performance rise of about 2× may be obtained by using 10% resource, and performance rise of about 3× may be obtained by using 20% resource;

Regarding the sorting algorithm, performance rise of about 5× may obtained by using 10% resource, and performance rise of about 10× may be obtained by using 15% resource.

Therefore, the expert knowledge may be put into the performance model to determine the predicted benefit. The expert knowledge for example may include one or more of: a type of a task executed at current stage of the distributed job, the acceleration performance of the FPGA for this type of task, and the demand for performance at the current stage of the distributed job, and so on.

Furthermore, the overhead varies for reconfiguring different parts of the FPGA. For example, if the whole FPGA chip is reconfigured, one minute might be needed, but all tasks using FPGA may be interrupted and corresponding software overhead needs to be introduced. If only partial FPGA is reconfigured, only one second might be needed, whereupon tasks using the reconfigured FPGA resource need to be interrupted, and corresponding software overhead is introduced accordingly. Estimation of the overhead for reconfiguring partial FPGA may be determined according to FPGA performance.

As shown at block S230, at least a part of the FPGA is dynamically reconfigured in response to determination of reconfiguring the FPGA. According to an embodiment of the present invention, when the FPGA is reconfigured, the resources for tasks of the distributed job may be reallocated, and furthermore, the at least part of the FPGA is dynamically reconfigured according to the reallocation of the resources. Furthermore, in the case that a part of the FPGA is dynamically reconfigured, other parts of the FPGA is not affected in running and continue executing respective tasks.

FIG. 3C illustrates an example of parallelism of Map tasks and Reduce tasks after acceleration of the reconfigured FPGA. The reconfigured FPGA allocates resources for respective tasks, and more resources may be used to execute the Reduce tasks in the second line. It can be seen that as compared with FIG. 3B, the time for executing Map tasks in the first and third lines and Reduce tasks in the fourth line are prolonged, and the time for executing Reduce tasks in the second line is shortened. Since these tasks all are parallel operations, this adjustment shortens the overall run-time of the MapReduce job so as to effectively improve load imbalance.

Note that although illustration is presented for handling of the distributed job by taking MapReduce as an example, those skilled in the art may understood that embodiments of the present invention are not limited to MapReduce, but applicable for various distributed applications, such as distributed crawlers, distributed databases, and distributed search engines. As long as the distributed applications include function modules that can be accelerated by FPGA, embodiments of the present invention may be used to improve the performance thereof.

According to an embodiment of the present invention, the FPGA here may include a FPGA card or a plurality of FPGA cards distributed on a plurality of devices. The plurality of FPGA cards may be shared by a plurality of tasks of the distributed job.

As such, the distributed job may be handled effectively through the method of the above embodiments to meet its different demands for performance, such that more FPGA resources may be placed on more crucial functions. For example, if the target is to obtain the best performance, adjustment is made in a way that how much FPGA logic should be used for compression and how much should be used for encryption, and so on, such that resources of the FPGA card can be used sufficiently.

Those skilled in the art may appreciate that the method may be implemented in software, hardware or a combination of software and hardware. Moreover, those skilled in the art may understand by implementing steps in the above method in software, hardware or a combination of software and hardware, there may be provided a system for handling a distributed job. Even if the system has the same hardware structure as a general-purpose processing device, the functionality of software contained therein makes the system manifest distinguishing properties from the general-purpose processing device, thereby forming the system in various embodiments of the present invention.

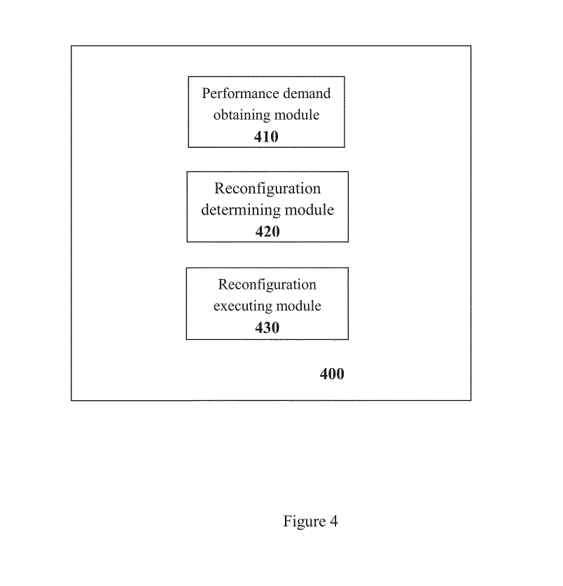

FIG. 4 illustrates a block diagram of a system 400 for handling a distributed job according to an embodiment of the present invention. As shown in FIG. 4, the system 400 comprises the following modules: a performance demand obtaining module 410, a reconfiguration determining module 420, and a reconfiguration executing module 430, where the performance demand obtaining module 410 is configured to obtain a demand for performance in the distributed job, the reconfiguration determining module 420 is configured to determine, according to the demand for performance, whether to reconfigure the FPGA, and the reconfiguration executing module 430 is configured to dynamically reconfigure at least a part of the FPGA in response to determination of reconfiguring the FPGA.

As stated above, when the load imbalance is detected to occur in the distributed job, it is believed that there exists a demand for performance of the distributed job at this time, whereupon the performance demand obtaining module 410 is configured to detect the load imbalance in the distributed job. The detection is performed by monitoring the progress of each task in the distributed job and determining whether there exists the load imbalance according to the progress of each task.

The reconfiguration determining module 420 determines whether to reconfigure the FPGA according to the demand for performance obtained by the performance demand obtaining module 410. According to an embodiment of the present invention, the reconfiguration determining module 420 may estimate an overhead and a predicted benefit for reconfiguring at least a part of the FPGA according to the demand for performance, and determine to reconfigure at least the part of the FPGA in response to the predicted benefit being greater than the overhead.

According to an embodiment of the present invention, the reconfiguration executing module 403 is further configured to reallocate a resource for a task of the distributed job according to the estimated overhead and the predicted benefit, and dynamically reconfigure at least the part of the FPGA according to the reallocation of the resource.

The prediction of the overhead and the benefit may be implemented by using a performance model based on expert knowledge, wherein the expert knowledge may include one or more of: a type of a task executed at current stage of the distributed job, acceleration performance of the FPGA for the type of the task, and a demand for performance at the current stage of the distributed job.

The present invention may be a system, a method, and/or a computer program product. The computer program product may include a computer readable storage medium having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for handling a distributed job, wherein the distributed job is handled by a FPGA, the method comprising:
obtaining a demand for performance in the distributed job;
determining, according to the demand for performance, whether to reconfigure the FPGA; and
dynamically reconfiguring at least a part of the FPGA in response to determination of reconfiguring the FPGA.

2. The method according to claim 1, wherein the distributed job is a MapReduce job.

3. The method according to claim 1, wherein the obtaining the demand for performance in the distributed job comprises detecting load imbalance in the distributed job.

4. The method according to claim 3, wherein the detecting the demand for load imbalance in the distributed job further comprises:
monitoring progress of each task of the distributed job; and
determining whether load imbalance exists according to the progress of each task.

5. The method according to claim 1, wherein the determining, according to the demand for performance, whether to reconfigure the FPGA comprises:
estimating an overhead and a predicted benefit for reconfiguring at least a part of the FPGA according to the demand for performance; and
determining to reconfigure at least the part of the FPGA in response to the predicted benefit being greater than the overhead.

6. The method according to claim 5, wherein the dynamically reconfiguring at least a part of the FPGA in response to determination of reconfiguring the FPGA comprises:
reallocating a resource for a task of the distributed job according to the estimated overhead and the predicted benefit; and
dynamically reconfiguring at least the part of the FPGA according to the reallocation of the resource.

7. The method according to claim 1, wherein the estimating an overhead and a predicted benefit for reconfiguring at least a part of the FPGA according to the demand for performance further comprises estimating the predicted benefit by using a performance model based on expert knowledge.

8. The method according to claim 7, wherein the expert knowledge includes one or more of: a type of a task executed at current stage of the distributed job, acceleration performance of the FPGA for the type of the task, and a demand for performance at the current stage of the distributed job.

9. The method according to claim 1, wherein the FPGA includes a plurality of FPGA cards distributed on a plurality of devices.

10. A system for handling a distributed job, wherein the distributed job is handled by a FPGA, the system comprising:
a performance demand obtaining module configured to obtain a demand for performance in the distributed job;
a reconfiguration determining module configured to determine, according to the demand for performance, whether to reconfigure the FPGA; and
a reconfiguration executing module configured to dynamically reconfigure at least a part of the FPGA in response to determination of reconfiguring the FPGA.

11. The system according to claim 10, wherein the distributed job is a MapReduce job.

12. The system according to claim 10, wherein the performance demand obtaining module is configured to detect load imbalance in the distributed job.

13. The system according to claim 12, wherein the performance demand obtaining module is further configured to:
monitor progress of each task of the distributed job; and
determine whether load imbalance exists according to the progress of each task.

14. The system according to claim 10, wherein the reconfiguration determining module is further configured to:
estimate an overhead and a predicted benefit for reconfiguring at least a part of the FPGA according to the demand for performance; and
determine to reconfigure at least the part of the FPGA in response to the predicted benefit being greater than the overhead.

15. The system according to claim 14, wherein the reconfiguration executing module is further configured to:
reallocate a resource for a task of the distributed job according to the estimated overhead and the predicted benefit; and
dynamically reconfigure at least the part of the FPGA according to the reallocation of the resource.

16. The system according to claim 10, wherein the reconfiguration determining module is further configured to estimate the predicted benefit by using a performance model based on expert knowledge.

17. The system according to claim 16, wherein the expert knowledge includes one or more of: a type of a task executed at current stage of the distributed job, acceleration performance of the FPGA for the type of the task, and a demand for performance at the current stage of the distributed job.

18. The system according to claim 10, wherein the FPGA includes a plurality of FPGA cards distributed on a plurality of devices.

19. A computer program product for handling a distributed job, the computer program product comprising:
a non-transitory storage medium readable by a processing circuit and storing instructions for execution by the processing circuit for performing a method comprising:
obtaining a demand for performance in the distributed job;
determining, according to the demand for performance, whether to reconfigure the FPGA; and
dynamically reconfiguring at least a part of the FPGA in response to determination of reconfiguring the FPGA.

20. The computer program product according to claim 19, wherein the determining, according to the demand for performance, whether to reconfigure the FPGA comprises:
estimating an overhead and a predicted benefit for reconfiguring at least a part of the FPGA according to the demand for performance; and
determining to reconfigure at least the part of the FPGA in response to the predicted benefit being greater than the overhead.
